(19) United States
(12) Patent Application Publication
(10) Pub. No.: US 2017/0080558 A1
(43) Pub. Date: Mar. 23, 2017

(54) TELEPRESENCE ROBOT WITH STABILIZATION MECHANISM

(71) Applicant: Double Robotics, Inc., Burlingame, CA (US)

(72) Inventors: David Cann, Burlingame, CA (US); Marc DeVidts, Burlingame, CA (US); Angela Bamblett, Burlingame, CA (US); Hector Saldana, Burlingame, CA (US)

(73) Assignee: Double Robotics, Inc., Burlingame, CA (US)

(21) Appl. No.: 15/372,184

(22) Filed: Dec. 7, 2016

Related U.S. Application Data
(63) Continuation-in-part of application No. 14/205,994, filed on Mar. 12, 2014, now Pat. No. 9,539,723.
(60) Provisional application No. 61/779,359, filed on Mar. 13, 2013.
(60) Provisional application No. 62/265,553, filed on Dec. 10, 2015.

(51) Int. Cl. B25J 5/00

(52) U.S. Cl. CPC B25J 5/007; Y10S 901/01

(57) ABSTRACT

A robot controllable by a portable device, the robot including: a support; a balancing module configured to balance the robot; and a base mounted to the support, the base including a first wheel coaxially aligned with a second wheel and a motor drivably coupled to the first and second wheel.

### CROSS-REFERENCE TO RELATED APPLICATIONS

This application is a continuation-in-part of U.S. application Ser. No. 14/205,994, filed on 12 Mar. 2014, which claims the benefit of U.S. Provisional Application Ser. No. 61/779,359, filed on 13 Mar. 2013, which are both incorporated in their entireties by this reference.

This application claims the benefit of U.S. Provisional Application Ser. No. 62/265,553, filed on 10 Dec. 2015, which is incorporated in its entirety by this reference.

### TECHNICAL FIELD

This invention relates generally to the robotics field, and more specifically to a new and useful telepresence robot with an autonomous stabilization mechanism in the robotics field.

### BACKGROUND

Telepresence systems are becoming increasingly desirable with the increased employment of distributed teams and decreased cost of teleconference infrastructure. However, conventional telepresence systems are typically designed for static desktop applications, and are unsuitable for applications in which a remote user views and interacts with a variety of remote spaces. While telepresence robots do exist, conventional robots tend to be specialized in a given field and are unsuitable for consumer use. Furthermore, due to their specialization, conventional robots tend to be expensive, bulky, and laborious to update. Thus, there is a need in the telepresence field to create a new and useful robot suitable for consumer consumption.

### BRIEF DESCRIPTION OF THE FIGURES

FIG. 1 is an isometric view of the telepresence robot.

FIGS. 2A and 2B are schematic representations of the telepresence robot responding to a first and second normal force applied to the right and left wheels, respectively.

FIG. 3 is an exploded view of a variation of the passive suspension mechanism.

FIG. 4 is a cutaway view of the variation of the passive suspension mechanism installed within the robot.

FIG. 5 is a cutaway isometric view from the top back of the variation of the passive suspension mechanism.

FIGS. 6A and 6B are cutaway isometric views from the top front of the variation of the passive suspension mechanism installed within the robot.

FIG. 7 is a front view of the variation of the passive suspension mechanism.

FIG. 8 is a side cutaway view of the variation of the passive suspension mechanism.

FIG. 9 is a side view of the variation of the passive suspension mechanism.

FIG. 10 is a front cutaway view of the variation of the passive suspension mechanism.

FIG. 11 is a schematic representation of telepresence robot operation.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

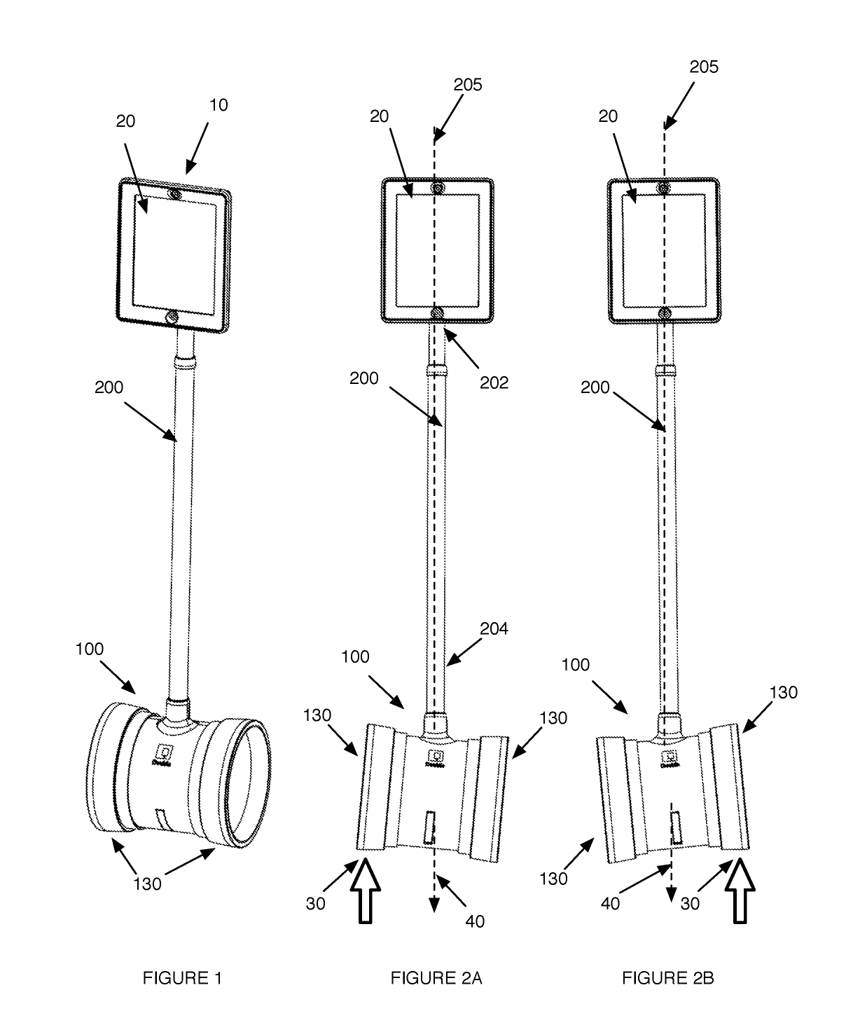

As shown in FIG. 1, the robot 10 includes a drive base 100, a support mounted to the drive base 100, a stabilization mechanism mounted to the drive base 100, and a head 500 removably mounted to the support 200 and configured to transiently retain a mobile device 20. The robot 10 functions to support and transport a mobile device 20 within a physical location, such as a room, a building, or a field. The mobile device 20 and robot cooperatively form a telepresence robot that is capable of displaying audio, video, and/or other data received from a remote device 50 and/or transmitting recorded audio, video, and/or other data to a remote device 50. The robot 10 can additionally function to automatically balance the mobile device 20 and/or support within a predetermined angular range relative to the gravity vector 40, but can alternatively perform any other suitable functionality. The telepresence robot is preferably remotely controlled, but can alternatively be automatically controlled, manually controlled, or otherwise controlled.

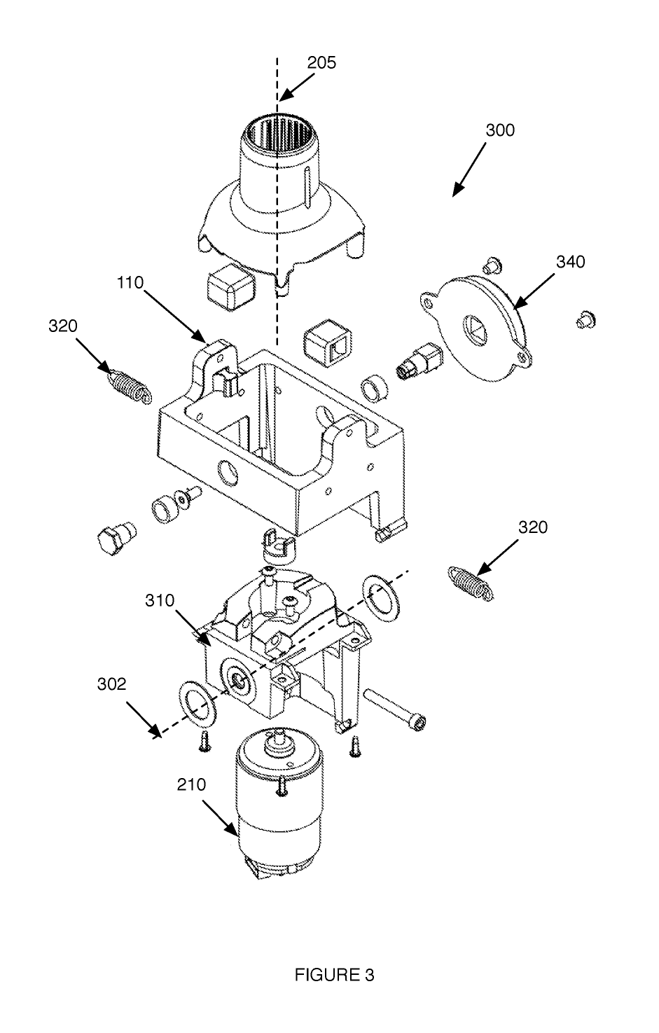

The telepresence robot confers several benefits over conventional systems. First, by including a stabilization mechanism, the telepresence robot functions to accommodate for sudden lateral motion (e.g., side-to-side motion, due to application of a force that is normal to the drive axis 102) due to bumps and sudden elevation changes that can upset and tip the robot 10, examples shown in FIGS. 2A and 2B. Second, by actively balancing the robot 10 with the drive motors 120, the telepresence robot can accommodate for sudden front-to-back motion. Third, by limiting the drive base 100 to two wheels 130 and actively balancing itself, the telepresence robot can minimize the size of the drive base 100, thereby minimizing the robot footprint. This can be desirable in indoor spaces, which have limited storage space and define small access points (e.g., narrow doorways, etc.). Fourth, by including a telescoping support, the robot 10 can dynamically move the user interface (e.g., the mobile device 20) between a plurality of vertical positions during operation, ranging from sitting heights to standing heights. This can enable the robot 10 (and the remote user) to dynamically switch between contexts.

The robot 10 is preferably used with a mobile device 20. The mobile device 20 preferably functions as the data output for the robot 10, and can additionally function as the data input for the robot 10. In a first example, the mobile device 20 can output audio and/or video for the robot 10, wherein the output audio and/or video can be received from a remote device 50. In a second example, the mobile device 20 can receive audio, video, haptic input, and/or any other suitable input for the robot 10, wherein the received input can be transmitted (e.g., wirelessly) to the remote device 50. However, the mobile device 20 can otherwise function as the robot 10 user interface.

The mobile device 20 can additionally control robot operation. In a first variation, the mobile device 20 can receive remote control instructions from the remote device 50 and communicate the remote control instructions to the drive base 100. The drive base 100 can then convert the remote control instructions into operation instructions (e.g., drive instructions, support operation instructions, etc.) and/or execute the remote control instructions or operation instructions. In a second variation, sensor data from the mobile device 20 (e.g., accelerometer measurements, gyroscope measurements, measurements from other orientation sensors, etc.) can be sent (e.g., through wireless or wired transmission) to the drive base 100. The drive base 100 can operate the robot 10 based on the mobile device sensor data, but the robot 10 can be additionally or otherwise operated based on the mobile device sensor data. For example, the drive base 100 can detect robot imbalance based on the mobile device sensor data, and operate the drive motors 120 to regain robot balance. In a second example, the drive base 100 can interpret the mobile device sensor data into navigation data (e.g., convert image data into obstruction data, drive path data, etc.) and automatically operate the robot 10 based on the navigation data. In a third variation, the mobile device 20 can generate operation instructions (e.g., drive motor control instructions, etc.) based on the mobile device sensor data and/or robot operation data received from the robot 10 (e.g., from the drive base 100, drive base 100 sensors, etc.), and control robot operation (e.g., drive base 100 operation, drive motor 120 operation, stabilization mechanism operation, etc.) using the operation instructions. However, the mobile device 20 can otherwise partially or entirely influence robot operation.

The drive base 100 of the robot 10 functions to retain the support 200, suspension mechanism 300, and remaining components of the robot 10. The drive base 100 can additionally function to enclose and protect the robot 10 components. The drive base 100 can include: a body, one or more wheels 130 (e.g., two wheels 130), one or more drive motors 120, one or more kickstands (e.g., that deploy when the robot 10 is not automatically balancing), a balancing mechanism (e.g., a gyroscope, counterweight, etc.), or any other suitable component. The drive base 100 preferably has substantially (e.g., within a predetermined error threshold) more mass than the support 200, mobile device 20, and/or both combined, but can alternatively have less mass, substantially equal mass (e.g., within 10%), or any suitable amount of mass. The drive base 100 is preferably substantially shorter in height than the support 200, but can alternatively be taller or have any other suitable height relative to the support 200. The drive base 100 is preferably substantially wider than the support 200 (e.g., more than 5 times wider), but can alternatively be thinner than the support 200 or have any other suitable lateral dimension.

The body of the drive base 100 functions as a mounting point and functions to house the robot 10 components. The body preferably includes a chassis no and a shell, wherein the chassis 110 functions as the mounting point and the shell encapsulates the robot 10 components therein. However, the body can include any other suitable set of components. The chassis 110 is preferably substantially rigid, but can alternatively be flexible. The shell is preferably substantially rigid, but can alternatively be flexible. The body is preferably cylindrical (e.g., defining a substantially constant body diameter), but can alternatively be rectangular prismatic, have any suitable polygonal cross section, or have any other suitable profile.

The wheels 130 of the drive base 100 function to translate the robot 10 along the ground. The drive base 100 preferably includes two wheels 130, but can alternatively include any suitable number of wheels 130. The wheels 130 are preferably coaxially aligned such that they share a common wheel axis, but can alternatively be arranged offset or in any other suitable configuration. The wheel axis can be collinear with a drive axis 102, parallel to and offset from the drive axis 102, or otherwise arranged. The wheels 130 are preferably arranged external the drive base 100, but can alternatively be arranged partially or entirely within the drive base 100. In one variation, the wheels 130 are arranged with the drive axis 102 offset from the central axis of the body, such that a portion of the wheels 130 extend beyond the drive base 100. In a second variation, the wheels 130 are arranged on opposing ends of the drive base 100, with the drive axis 102 substantially coaxial with the central axis of the body. In this variation, the wheels 130 preferably have a diameter larger than the body diameter, such that the wheels 130 enclose a portion of the respective body end. However, the wheels 130 can be otherwise arranged.

The drive motor 120 of the drive base 100 functions to drive the wheels 130. The drive motor 120 preferably drives the wheels 130 in response to drive commands received from the processor 400, but can alternatively drive the wheels 130 in response to drive commands received from the mobile device 20 or any other suitable source. The drive motor 120 can drive the wheels 130 to translate within a physical space, and can additionally drive the wheels 130 to dynamically balance the support 200 relative to a gravity vector 40. For example, the drive motor 120 can drive the wheels 130 to balance the robot about a tilt axis by maintaining the position of the support 200 (e.g., support longitudinal axis) relative to a gravity vector 40 (e.g., within a predetermined range of angles relative to the gravity vector 40, within a predetermined range of tilt angles relative to a plane including the tilt axis and the gravity vector 40). The tilt axis can be collinear with the wheel axis, parallel to but displaced from the wheel axis, or can be any other suitable axis.

The drive motor 120 is preferably connected to a wheel 130 and the processor 400, but can alternatively be otherwise connected to any other suitable component. The drive motor 120 is preferably hardwired to the processor 400, but can alternatively be wirelessly connected to the processor 400. The drive motor 120 can be connected to the respective wheels 130 by a belt drive, drive shaft, transmission gears (e.g., gearbox), a set of paired magnets, or by any other suitable power transmission system. The power transmission system can be shared between drive motors 120, or be individual to each drive motor 120. The drive motor 120 is preferably mounted to the chassis 110, but can alternatively be mounted to any other suitable component. The drive motor 120 is preferably arranged within the body, but can alternatively be arranged outside of the body (e.g., between the wheel 130 and the body) or arranged at any other suitable location.

The drive motors 120 are preferably electric motors, but can alternatively be any other suitable type of motor. Examples of drive motors 120 include: AC motors (e.g., induction motors, brushless motors, etc.), DC motors (e.g., homopolar motors, mouse mill motors, brushless motors, etc.), electrostatic motors, or any other suitable motor.

The robot 10 preferably includes a drive motor 120 for each wheel 130 (e.g., two drive motors 120 when the robot 10 includes two wheels 130, wherein each drive motor 120 is connected to a single wheel 130), but can alternatively include a drive motor 120 for each set of coaxial wheels 130, or include any suitable number of drive motors 120. When the robot 10 includes multiple drive motors 120, the drive motors 120 can be substantially similar or different. The drive motor 120 can additionally include a set of sensors (e.g., motor encoders, etc.) that function to measure drive motor 120 operation, wherein the sensor measurements can be used by the processor 400 in drive motor control.

The support 200 of the robot 10 functions to support the mobile device 20. The support 200 is preferably a linear member (e.g., a bar), and defines a first end 202, second end 204 opposing the first end 202, and body extending therebetween. The support 200 can additionally define a longitudinal axis 205 extending along the body. The first end 202 of the support 200 is preferably configured to support the mobile device 20 (e.g., include a head 500 or be removably coupled to a head 500), but can alternatively be configured to support any other suitable device. The second end 204 of the support 200 is preferably mounted to the drive base 100, more preferably indirectly mounted to the drive base 100 through the suspension mechanism 300 but alternatively directly mounted to the chassis no or any other suitable portion of the drive base 100. The support 200 is preferably mounted with the longitudinal axis substantially perpendicular to (e.g., normal to) and intersecting the drive axis 102 and/or wheel axis, but can alternatively be mounted with the longitudinal axis offset from the drive axis 102, at an angle to the drive axis 102, or in any other suitable configuration.

The support 200 can have a substantially static (e.g., fixed) length or an adjustable length (e.g., include an extendable member configured to adjust the length of the support). In the latter variant, the support 200 can additionally function to move the mobile device 20 between a set of vertical positions, ranging from an extended position to a retracted position (e.g., based on height instructions received from the portable device, such as during robot translation). In a specific example, the support 200 can move the mobile device 20 between a substantially continuous set of positions, ranging from 0.5 ft (e.g., retracted/storage position) to 5.5 ft (e.g., a standing position). In a second specific example, the support 200 can move the mobile device 20 between the 0.5 ft (e.g., retracted/storage position), to 2.5 ft (e.g., a seated position), to 5.5 ft (e.g., a standing position). However, the support 200 can move the mobile device 20 between any suitable set of positions. Examples of the actuatable support include a telescoping support (e.g., including a first and second nesting piece), rail (e.g., including a first element that slides linearly along a second element), or any other suitable support.

In this variant, the support 200 can additionally include an actuator configured to adjust the support 200 length. The actuator can be a mechanical actuator, such as a screw (e.g., leadscrew, screw jack, ball screw, roller screw), a wheel 130 and axle (e.g., a hoist, winch, rack and pinion, chain drive, belt drive, rigid chain, and rigid belt), a cam, or any other suitable mechanical actuator.

In this variant, the actuator can additionally include a support motor 210 that functions to actuate the support 200 between the set of positions. The support motor 210 can be an electric motor (e.g., an AC motor, DC motor, electromagnetic motor, etc.), or be any other suitable motor. The support motor 210 is preferably drivably connected to the second end of the support 200, more preferably to the translation component 220 (e.g., the screw, wheel 130 and axle, cam, etc.), but can alternatively be connected to any other support component. The support motor 210 preferably includes a body and a shaft, wherein the shaft is preferably statically connected to the translating component of the mechanical actuator (e.g., wherein the support motor 210 is connected to the support at a first end of the support motor). The body of the support motor 210 is preferably statically mounted to the second end of the support 200, but can alternatively be movably mounted to the second end. The support motor 210 (e.g., the support motor body) can be directly or indirectly mounted to the drive base 100 (e.g., the chassis no, through the suspension mechanism 300), wherein the support motor 210 can be statically or movably mounted to the drive base 100 and/or mounting component (e.g., suspension mechanism 300).

In one variation, the support motor 210 is statically mounted to the support mount 310, such that the support motor 210 is rotatably coupled to the drive base 100. The support motor 210 is preferably mounted to the support mount 310 with the majority of the support motor volume and/or mass below the rotational axis 302 of the support mount 310 (e.g., distal the first or second end of the support, proximal the contact surface of the wheels, with the rotational axis 302 arranged between the second end of the support and the opposing end of the support motor, etc.), but can additionally or alternatively be mounted with half or more of the support motor volume and/or mass arranged above the rotational axis. However, the support motor 210 can be mounted in any suitable configuration. In a second variation, the support motor 210 is statically mounted to the drive base 100, wherein the support motor output is connected to the driven end of the support by a universal joint. In a third variation, the support motor 210 is mounted within the support shaft, at or above the rotational axis 302 of the support mount 310. However, the support motor 210 can be otherwise mounted to the system.

However, the actuator can be a hydraulic actuator, pneumatic actuator, piezoelectric actuator, electro-mechanical actuator (e.g., worm gear, travelling-nut linear actuator, travelling-screw linear actuator, etc.), linear motor, telescoping linear actuator, or include any other suitable actuator. The actuator can extend along the entire length of the support 200, extend from the second end and terminate along the support 200 length, or be mounted to any other suitable portion of the support 200.

The suspension mechanism 300 of the robot 10 functions to dynamically accommodate for lateral robot imbalance (e.g., angular jerk along a lateral plane, lateral tipping, etc.). This motion can be due to uneven normal force 30 application to one of the two wheels 130 (e.g., abrupt bumps or elevation changes), which can elevate one wheel 130 relative to the other. Due to the long support and weight of the mobile device 20, the robot 10's center of gravity (center of mass) is far removed from the drive base 100. When the wheels 130 are laterally misaligned due to the elevation difference, a statically mounted support will tip along with the drive base 100, effectively moving the center of gravity outside of the boundaries of the drive base 100 (e.g., placing the center of gravity beyond the drive base 100 width). This center of gravity placement, coupled with the length of the support 200, generates a moment of inertia that promotes wheel 130 lift and robot tipping (e.g., roll, wherein the robot 10 falls over laterally or to the side; wherein some or all of the robot 10 rotates about a roll axis, such as an axis perpendicular the tilt axis and/or wheel axis, axis parallel the ground, etc.). The suspension mechanism 300 functions to partially or entirely isolate support movement along this axis (e.g., be configured to accommodate for support rotation along a plane including a drive axis 102 of the drive base boo; accommodate for support rotation about an axis substantially perpendicular to a gravity vector, such as an axis substantially parallel or perpendicular to the drive axis 102; accommodate for support rotation about an axis normal to the drive axis 102 and the longitudinal axis; accommodate for support rotation about an axis normal to a plane including a drive axis 102 of the drive base 100; etc.), which can prevent or reduce robot roll and/or increase the angle that the drive base 100 central axis can be oriented relative to a horizontal axis (e.g., an axis perpendicular to a gravity vector 40) without robot tipping. In one variation, upon drive base 100 imbalance (e.g., lateral tipping due to a bump, etc.), the inertia of the long support and mobile device 20 keeps the support 200 and mobile device 20 substantially vertical (e.g., aligned with a gravity vector 40), while the drive base 100 is allowed to roll, independent of the support 200, to accommodate for the imbalance.

The suspension mechanism 300 preferably mounts the support 200 to the drive base 100, but can alternatively mount any other suitable component to the drive base 100. More preferably, the suspension mechanism 300 mounts the second end of the support 200 and/or the support motor 210 to the drive base 100. The suspension mechanism 300 can statically mount the support motor 210 (e.g., the support motor body), statically mount the support 200 (e.g., the second end of the support 200), movably mount the support motor 210 (e.g., the support motor body, wherein the support motor 210 can rotate or linearly actuate relative to the suspension mechanism 300), movably mount the support 200 (e.g., the second end of the support 200, wherein the support 200 can rotate or linearly actuate relative to the suspension mechanism 300), or otherwise mount the support 200 and/or support motor 210. The suspension mechanism 300 is preferably rotatably mounted (e.g., allowing relative rotation about one or more axes, such as the roll axis, tilt axis, etc.) to the drive base 100 (e.g., the chassis 110), but can alternatively be statically mounted or otherwise mounted to the drive base 100. The suspension mechanism 300 can be configured to balance the robot (e.g., about a single rotational axis, such as a roll axis; about multiple rotational axes; etc.).

In a first variation, the suspension mechanism 300 is a passive mechanism, example shown in FIG. 3. The passive suspension mechanism 300 (e.g., passive and/or mechanical balancing module) can include a support mount 310 and a return mechanism (e.g., set of springs 320, piston, etc.). The passive suspension mechanism 300 can additionally include a damper 340.

The support mount 310 is preferably substantially rigid, and defines a cage with a first end and a second end. The first end of the cage mounts the support second end 204 (e.g., permits support motor 210 shaft extension therethrough), while the second end of the cage extends along all or a portion of the support motor body length. The first end of the support mount 310 can be statically mounted (e.g., rigidly mounted) to the support motor 210 and/or support second end. However, the support mount 310 can be otherwise mounted to the support motor 210 and/or support second end. The support mount 310 is preferably rotatably mounted to the drive base 100 (e.g., chassis no), but can alternatively be mounted to any other suitable component. In one embodiment, the support mount 310 is mounted such that the support mount 310 can rotate about a rotational axis 302 that is perpendicular to both the drive axis 102 and support longitudinal axis 205. In variants in which the support motor 210 is statically mounted to the support mount 310, this configuration can rotatably mount the support motor 210 to the drive base 100 (e.g., chassis 110), such that the support motor 210 can angularly actuate within a plane that extends along a drive axis 102 of the drive base 100 and the support longitudinal axis 205 (suspension plane 304). The support mount 310 is preferably mounted to the drive base 100 along the rotational axis 302 (e.g., along the roll axis), but can alternatively be mounted along any other suitable portion of the support mount 310. In one embodiment, the first end of the support mount 310 includes a mounting point, wherein a bolt or other mounting mechanism can pass through the mounting point and the chassis 110 to rotatably mount the support mount 310 to the chassis no. In this embodiment, the rotational axis 302 preferably passes through the mounting point, but can alternatively be arranged along any other suitable portion of the support mount 310. In a specific example (shown in FIG. 3), the first end of the support mount 310 includes a first and second coaxial mounting point, each defined through an opposing side of the support mount 310 (e.g., the front and back face of the support mount 310), wherein the mounting point axes are perpendicular the drive axis 102 when the support mount 310 is mounted with the longitudinal axis 205 substantially perpendicular the drive axis 102.

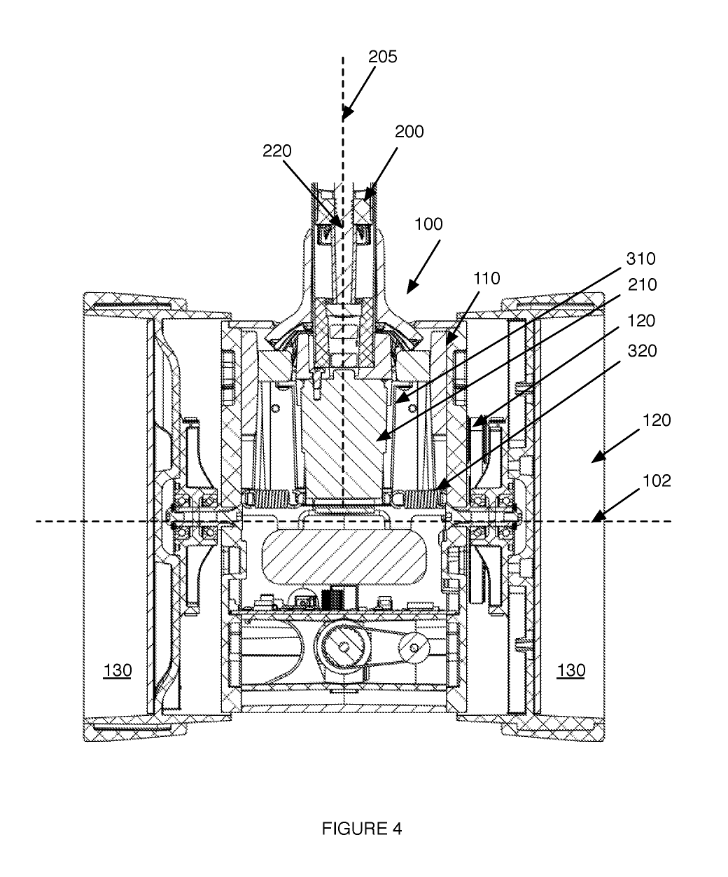

The return mechanism of the passive suspension mechanism 300 function to provide a return force (e.g., thereby exerting a return torque about a rotational axis, such as an axis of the support mount 310) when the support motor 210 and/or support mount 310 is angularly displaced along the suspension plane 304 (e.g., displaced from an equilibrium position, such as a central or upright position, wherein the force and/or torque is preferably directed toward the equilibrium position). The passive suspension mechanism 300 preferably includes a pair of springs 320, but can alternatively include any suitable number of springs 320 or spring pairs, one or more pistons, and/or any other suitable return mechanism(s). Each spring 320 within a pair preferably has substantially the same spring constant, but can alternatively have different spring constants. Each spring 320 is preferably connected to the support motor 210 and/or support mount 310 at a first end of the spring 320 and connected to the drive base 100 (e.g., the chassis no) at the second end of the spring 320. However, the springs 320 can be connected to any other suitable component. The springs 320 are preferably connected to a bottom end of the support motor 210 and/or support mount 310 (e.g., end opposing the first end of the support), but can alternatively be connected to the top end of the support motor 210 and/or support mount 310, along the body of the support motor 210 and/or support mount 310, or along any other suitable portion of the support motor 210 and/or support mount 310. As shown in FIG. 4, each spring 320 of a pair is preferably coupled (e.g., mounted, hooked, etc.) on an opposing side of the support motor 210 and/or support mount 310 (e.g., with the first of the pair on the first side and the second of the pair on the second side) and connects the respective side of the support motor 210 and/or support mount 310 to the drive base 100, but can alternatively be otherwise arranged. The spring pairs are preferably coaxially arranged (e.g., with respective spring 320 axes substantially parallel the drive axis 102, substantially perpendicular the roll axis, etc.), but can alternatively be otherwise arranged. In one specific example, the suspension mechanism 300 includes a spring pair, wherein both springs 320 are connected to opposing sides of the second end of the support mount 310 at a first end, and connected to the chassis 110 at the second end. The springs 320 can have a fixed spring constant, variable spring constant, or have any other suitable spring constant. Examples of springs 320 that can be used include: tension springs, compression springs, torsion springs, constant springs, variable springs, or any other suitable type of spring. The spring constant can be 45 lbs/in, 30 lbs/in, 10 lbs/in, or have any other suitable spring constant.

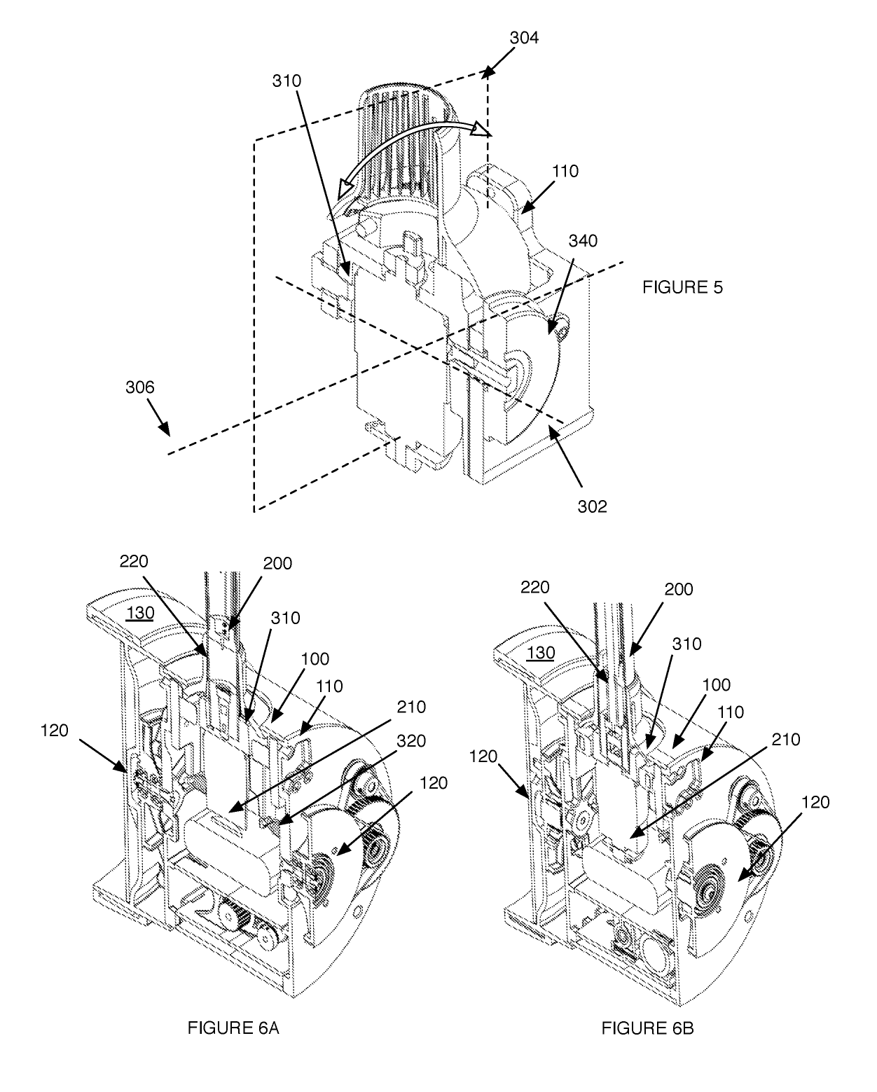

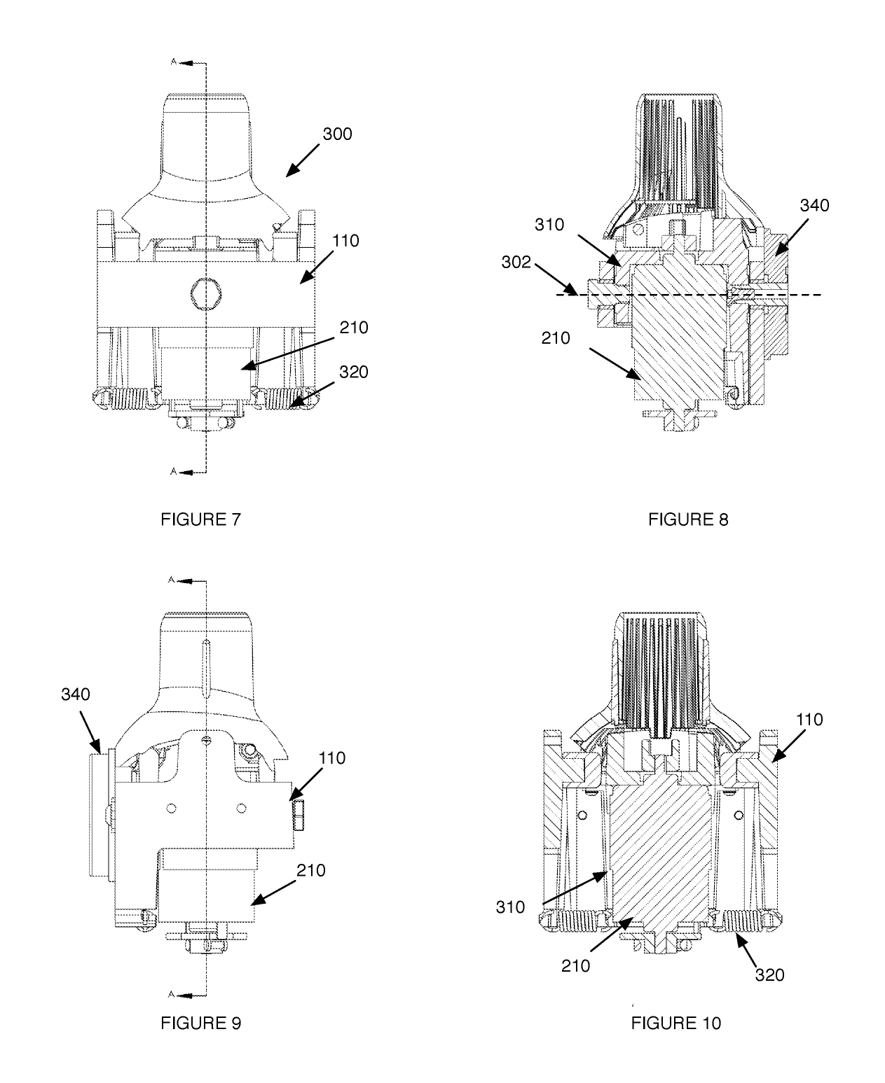

As shown in FIGS. 3 and 5, the suspension mechanism 300 can additionally include a damper 340 that functions to damp angular movement of the support motor 210 and/or support mount 310 along the suspension plane 304 (e.g., be configured to resist support rotation about an axis normal to the drive axis 102 and the longitudinal axis; configured to resist support rotation about a normal axis to the plane including a drive axis 102 of the drive base 100; configured to resist support rotation about an axis substantially perpendicular to a gravity vector, such as an axis substantially parallel or perpendicular to the drive axis 102, etc.). The damper 340 is preferably mounted to the support mount 310 at a first end, and mounted to the drive base 100 (e.g., the chassis no) along a second end. The damper 340 can be statically mounted (e.g., rigidly mounted), movably mounted, or otherwise mounted to the support mount 310 and/or chassis 110. The damper 340 preferably defines a broad face along each end, wherein the damper 340 is coupled to the respective component along the broad face. However, the damper 340 can be otherwise coupled to the respective component. The damper 340 can be arranged with the broad face parallel to and offset from the suspension plane 304 (e.g., with the normal of the broad face parallel the rotational axis 302), but can alternatively be otherwise arranged. The damper 340 can be passive or active. The damper 340 can be a disc damper 340 (e.g., include a first and second disc with a viscous fluid, Newtonian fluid, non-Newtonian fluid, and/or any other suitable fluid therebetween), a torsion spring, or be any other suitable damper 340. The damper 340 can have a substantially constant damping coefficient (e.g., exert a damping force proportional to the support angular or linear velocity), variable damping coefficient, or any other suitable damping coefficient. In examples, the damper 340 can have a damping force of 45 lbs/in, 50 lbs/in, 30 lbs/in, or any other suitable damping force. The robot preferably includes a single damper 340, but can alternatively include any suitable number of dampers.

In a second variation, the suspension mechanism 300 is an active suspension mechanism 300. In this variation, support mount 310, support, and/or support motor 210 rotation along the suspension plane 304 can be dynamically controlled by active components, such as a suspension motor. In one example, the active suspension mechanism 300 can include: a support mount 310, a suspension motor, encoder, gyroscope, and accelerometer, wherein the active suspension mechanism 300 components cooperatively maintain the lateral position of the support 200 (e.g., support longitudinal axis) relative to a gravity vector 40 (e.g., within a predetermined range of angles relative to the gravity vector 40, within a predetermined range of roll angles relative to a plane including a roll axis and the gravity vector 40).

The support mount 310 of the active suspension mechanism 300 can be substantially similar to that of the passive suspension mechanism 300, and function to isolate lateral rotation of the support 200 and/or support motor 210 from the drive base 100.

The suspension motor of the active suspension mechanism 300 can function to actively adjust the angular position of the support 200, support motor 210, and/or support mount 310 within the suspension plane 304 (e.g., about the rotational axis 302, relative to a gravity vector 40, relative to a normal vector to the drive axis 102, etc.; wherein the suspension plane can be a plane extending along a gravity vector and the tilt axis, or be otherwise defined). The suspension motor, more preferably the shaft but alternatively any other suitable portion, can be statically (e.g., rigidly) mounted to the support 200, support motor 210, and/or support mount 310, but can alternatively be otherwise connected to the support 200 system (e.g., support, support motor 210, and/or support mount 310). The suspension motor can be an electric motor (e.g., AC motor, DC motor, electromagnetic motor, etc.), or be any other suitable motor. The suspension motor is preferably arranged with a drive axis 102 perpendicular to the drive axis 102 and/or longitudinal axis of the support motor 210, the longitudinal axis 205 of the support 200, the longitudinal axis of the support mount 310, the suspension plane 304, and/or parallel to the rotational axis 302, but can alternatively be otherwise mounted. The body of the suspension motor is preferably mounted to the chassis 110, but can alternatively be otherwise mounted.

The encoder of the active suspension mechanism 300 functions to determine the angular position of the suspension motor shaft, wherein the angular position of the suspension motor shaft can be used as a proxy for the angular position of the support 200 system, or be otherwise used. In one example, the measured angular position can be used to determine whether the suspension motor shaft and/or support system has been positioned at the requisite angle to offset the drive base 100 lateral tilt. The encoder is preferably connected to the processor 400, but can alternatively be connected to any other suitable processing system.

The gyroscope and/or accelerometer of the active suspension mechanism 300 can be used to determine the angular acceleration of the support 200 system within the suspension plane 304, which can be used as an input into the active suspension mechanism 300. However, the gyroscope and/or accelerometer can be otherwise used. The gyroscope is preferably mounted to the processor, but can alternatively be mounted to the support system (e.g., the support 200, the support mount 310, the support motor body, etc.) or any other suitable robot component.

In one variation, in response to measurements indicative of support system lateral acceleration (e.g., within the suspension plane 304) by the gyroscope and/or accelerometer, the processor 400 can determine an angular position of the support system configured to offset the lateral acceleration (e.g., relative to a drive axis 102 normal), and control the suspension motor to adjust the support 200 system angular position to substantially match the determined angular position. Suspension motor actuation can be halted once the encoder indicates that the shaft (and therefore, the support 200 system) has rotated the requisite distance to place the support 200 system at the determined angular position. However, the active suspension mechanism 300 can be otherwise used.

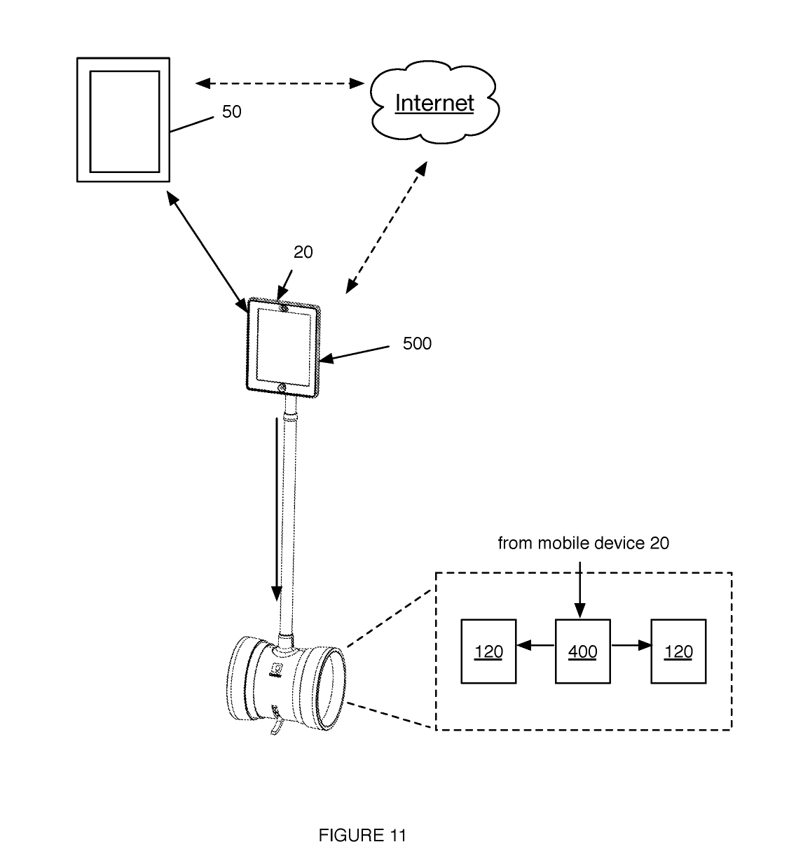

The processor 400 of the robot 10 functions to control the drive base 100. In particular, the processor 400 controls operation of the drive motors 120, and can additionally control operation of the support motor 210, the suspension motor, and/or any other suitable motor of the robot 10. The processor 400 is preferably hardwired or wirelessly connected to the respective motors. As shown in FIG. 11, the processor 400 can control the drive motor 120 to translate the robot 10 along a drive surface based on traversal instructions, automatically balance the robot 10 (e.g., about one or more axes of rotation, such as the tilt axis, roll axis, etc.) and/or maintain the support 200 and/or mobile device 20 within a range of vertical positions (e.g., by measuring the position or direction of acceleration of the support 200 and/or mobile device 20 and controlling the drive motors 120 to move the drive base 100 under the support 200) and/or angles (e.g., tilt angles, such as angles relative to a plane, such as plane 304, including the tilt axis and a gravity vector; roll angles, such as relative to a plane including the roll axis and a gravity vector; etc.), or otherwise control the drive motors 120. The traversal instructions can be generated by the remote device 50, mobile device 20, the processor 400, or any other device. The traversal instructions can be received by the processor 400 from a remote device 50 (e.g., received from the remote device 50 by the mobile device 20 and relayed to the processor 400, received directly by the processor 400 from the remote device 50, etc.), received from the mobile device 20 (e.g., based on images or sound maps recorded by the mobile device 20 and/or robot sensors), or otherwise determined.

The processor 400 can additionally function to receive and process sensor measurements, wherein the processor 400 can control the motors based on the sensor measurements, send the sensor measurements to the mobile device 20 or the remote device 50, or otherwise process the sensor measurements. The processor 400 is preferably hardwired or wirelessly connected to the respective sensors, but can alternatively indirectly receive the sensor measurements (e.g., through the mobile device 20, etc.). The sensors from which the sensor measurements are received can be: robot sensors (e.g., mounted to the processor 400, drive base 100, support, suspension mechanism 300, wheels 130, or other robot component), mobile device sensors (e.g., mobile device orientation or inertial sensors, such as accelerometers or gyroscopes; camera; light sensor; microphone; etc.), remote device sensors, or any other suitable sensor. The balancing instructions can be generated by the remote device 50, mobile device 20, the processor 400, or any other device. The processor 400 preferably dynamically balances the robot 10 (e.g., about a tilt axis 306, such as an axis parallel to or collinear with a drive axis 102) based on balancing instructions, wherein the balancing instructions can be received by the processor 400 from a remote device 50 (e.g., received from the remote device 50 by the mobile device 20 and relayed to the processor 400, received directly by the processor 400 from the remote device 50, etc.), received from the mobile device 20 (e.g., based on images or sound maps recorded by the mobile device 20 and/or robot sensors), or otherwise determined. The processor 400 preferably balances the robot during robot traversal, but can alternatively balance the robot at standstill or at any other suitable time. In one example, the processor 400 can balance the robot as the robot is concurrently traversing through a physical space and changing the support length (e.g., increasing or decreasing the support length).

The balancing instructions can be determined in response to sensor measurements exceeding a threshold value, in response to the pattern of measurements substantially matching a predetermined pattern, at a predetermined frequency, or at any other suitable time. The balancing instructions can be determined based on the sensor measurements, component operation parameters (e.g., instantaneous support length, center of mass lateral and/or vertical position, robot traversal speed, etc.), or based on any other suitable parameter. For example, the balancing instructions can be determined (and/or executed) in response to the orientation sensor measurements exceeding a threshold value (e.g., in response to the gyroscope or accelerometer measurements exceeding a threshold value), wherein parameters of the balancing instructions (e.g., wheel angular acceleration, etc.) can be determined based on the measurement values. In another example, the balancing instructions are determined based on the sensor measurement and an instantaneous or anticipated support height (e.g., support length). However, the robot can be otherwise balanced.

The processor 400 is preferably mounted within the drive base 100, but can alternatively be mounted in any other suitable position on the robot 10. The processor 400 can be a microprocessor 400, CPU, GPU, or any other suitable processing system. The processor 400 can additionally include sensors, memory, or any other suitable set of computing components.

As shown in FIG. 11, the robot 10 can additionally include a head 500, configured to retain and support the mobile device 20. The head 500 is preferably removably couplable to the support 200, more preferably the first end 202 but alternatively any other suitable portion of the support 200. The head 500 preferably removably couples the mobile device 20, but can alternatively permanently couple the mobile device 20 or otherwise couple the mobile device 20. Alternatively, the mobile device 20 can be coupled to the support 200 without a head 500. The head 500 can include a set of wired connections that electrically connect the mobile device 20 with the processor 400. The wired connections preferably electrically connect to a set of wires extending along the support 200 to the processor 400, but can alternatively electrically connect to any other suitable endpoint. Alternatively, the mobile device 20 can be wirelessly connected to the processor 400.

The robot 10 can additionally include a navigation mechanism that functions to facilitate robot navigation. In one variation, the navigation mechanism can include a mirror mounted to the head 500 and aligned with an optical sensor (e.g., camera) of the mobile device 20. The reflected image, recorded by the optical sensor, can be transmitted to the remote device 50. Alternatively, the mobile device 20 can automatically process the reflected image into traversal instructions. In a second variation, the navigation mechanism can include a LIDAR system, wherein the LIDAR processing can be performed by the mobile device 20. However, the robot 10 can include any other suitable navigation mechanism.

Although omitted for conciseness, the preferred embodiments include every combination and permutation of the various system components and the various method processes, wherein the method processes can be performed in any suitable order, sequentially or concurrently.

As a person skilled in the art will recognize from the previous detailed description and from the figures and claims, modifications and changes can be made to the preferred embodiments of the invention without departing from the scope of this invention defined in the following claims.

We claim:

1. A robot controllable by a portable device, the robot comprising:
a support comprising a longitudinal axis;
a base mounted to the support, the base defining a tilt axis and a roll axis perpendicular the tilt axis, the base comprising:
a first wheel coaxially aligned with a second wheel along a wheel axis parallel the tilt axis;
a first motor drivably coupled to the first and second wheel;
a processor configured to balance the robot about the tilt axis by maintaining the longitudinal axis within a predetermined range of tilt angles relative to a plane comprising the tilt axis and a gravity vector, based on a set of inertial sensor data; and
a balancing module configured to balance the robot about the roll axis.

2. The robot of claim 1, wherein the balancing module comprises a passive balancing module.

3. The robot of claim 2, wherein the passive balancing module comprises:
a support mount statically mounted to the support and rotatably mounted to the base about the roll axis;
a damper rigidly mounted to the support and to the base, the damper configured to resist rotation of the support about the roll axis; and
a return mechanism coupling the support to the base, the return mechanism configured to exert a torque on the support about the roll axis, the torque directed toward an equilibrium position of the support.

4. The robot of claim 3, wherein the return mechanism comprises a first spring connecting the support mount to the base.

5. The robot of claim 4, wherein the return mechanism further comprises a second spring connecting the support mount to the base, the first spring arranged opposing the second spring across the support mount, the first and second springs coaxially aligned along an axis parallel the wheel axis.

6. The robot of claim 1, wherein the longitudinal axis intersects the wheel axis.

7. The robot of claim 1, wherein the support comprises an extendable member configured to adjust a length of the support based on height instructions received from the portable device during robot translation, wherein adjustment of the length of the support adjusts a vertical position of a center of mass of the robot.

8. The robot of claim 7, wherein the processor is further configured to balance the robot about the tilt axis based on the length of the support.

9. The robot of claim 8, wherein the set of inertial sensor data is received from and generated by the portable device.

10. The robot of claim 7, wherein the support further comprises a support motor configured to control extension of the extendable member, the support motor controlled by at least one of the portable device and the processor.

11. The robot of claim 10, wherein the extendable member comprises a telescoping linear actuator driven by the support motor.

12. A robot controllable by a portable device, the robot comprising:
a support comprising a longitudinal axis;
a base comprising:
a first wheel coaxially aligned with a second wheel along a wheel axis; and
a first motor drivably coupled to the first and second wheel; and
a mechanical balancing module rotatably mounting the support to the base and configured to balance the robot about a roll axis, the mechanical balancing module comprising:
a support mount rotatably mounting the support to the base about the roll axis;
a damper rigidly mounted to the support and to the base, the damper configured to resist rotation of the support about the roll axis; and
a return mechanism coupling the support to the base, the return mechanism configured to exert a torque on the support about the roll axis, the torque directed toward an equilibrium position of the support.

13. The robot of claim 12, wherein the roll axis is perpendicular the wheel axis.

14. The robot of claim 12, wherein the support comprises an extendable member configured to automatically adjust a length of the support based on height instructions received from the portable device during robot operation.

15. The robot of claim 14, wherein the support comprises a support motor statically mounted to the support mount and drivably connected to the extendable member at a first support motor end.

16. The robot of claim 15, wherein the support motor comprises a support motor mass, wherein the support motor is mounted to the support mount with a majority of the support motor mass arranged opposing the first support motor end across the roll axis.

17. The robot of claim 15, wherein the return mechanism comprises a first spring and a second spring each connecting the support motor to the base, the first spring arranged opposing the second spring across the support mount, the first and second springs coaxially aligned perpendicular the roll axis.

18. The robot of claim 17, wherein the first and second springs are attached to a second support motor end opposing the first support motor end.

19. The robot of claim 14, further comprising a processor configured to balance the robot about a tilt axis perpendicular the roll axis by maintaining the longitudinal axis of the support within a predetermined range of tilt angles relative to a plane comprising the tilt axis and a gravity vector, based on a set of inertial sensor data, during robot operation.

20. The robot of claim 19, wherein the set of inertial sensor data is received from and generated by the portable device.
